(19) United States
(12) Patent Application Publication
(10) Pub. No.: US 2006/0265174 A1
(43) Pub. Date: Nov. 23, 2006

(54) Thermal sensing for integrated circuits

(76) Inventors: Bruce A. Doyle, Longmont, CO (US); Samuel D. Naffziger, Fort Collins, CO (US); Christopher A. Poirier, Fort Collins, CO (US); James S. Ignowski, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/132,055

(22) Filed: May 18, 2005

(51) Int. Cl. G01K 1/00

(52) U.S. Cl. 702/130

(57) ABSTRACT

A thermal sensing system may comprise a plurality of remote sensors distributed across an integrated circuit (IC). Each of the plurality of remote sensors provides an analog signal that varies as a function of temperature of a respective region of the IC where each respective remote sensor is located. A central system, forming part of the IC, samples the analog signals from the plurality of remote sensors and converts the sampled analog signals to corresponding digital values.

### BACKGROUND

Integrated circuit (IC) chips can include circuitry for detecting temperature of the IC die. A typical thermal sensing circuit utilizes a comparator to ascertain whether temperature at a given site exceeds a predetermined threshold. This determination can be made, for example, by comparing voltage across an integrated diode relative to a temperature independent threshold voltage.

### BRIEF DESCRIPTION OF THE DRAWINGS

FIG. 1 depicts an embodiment of a thermal sensing system.

FIG. 2 depicts another embodiment of a thermal sensing system.

FIG. 3 depicts an embodiment of circuitry that can be employed to generate a thermal reference.

FIG. 4 is a timing diagram illustrating various signals that can be generated in an embodiment of a thermal sensing system.

FIG. 5 depicts an example of an embodiment of a method for implementing thermal sensing in an integrated circuit.

### DETAILED DESCRIPTION

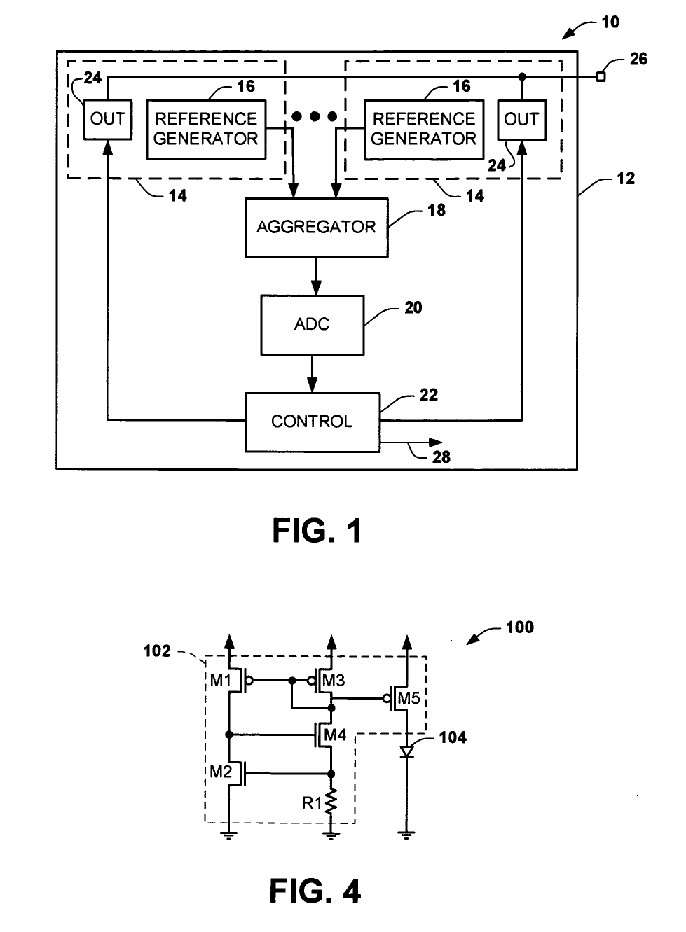

FIG. 1 depicts an example of the thermal sensing system 10. The thermal sensing system 10 can be implemented in an integrated circuit (IC), schematically indicated at 12. The thermal sensing system includes a plurality of remote sensors 14 distributed across the IC 12. The IC 12 can be implemented on an IC die, alone or in combination with other circuitry. As used herein, the term “IC die” refers to a single piece of semiconductor containing one or more circuits, commonly referred to as an IC chip. For example, the remote sensors 14 can be positioned at locations on the IC 12 that are predefined based on expected power consumption of other circuitry implemented on the IC 12. By positioning the respective remote sensors 14 at areas of expected high power consumption, the sensing system 10 can more accurately detect “hot spots” across the IC 12.

The remote sensors 14 provide information indicative of temperature on the die. In the example, of FIG. 1, each of the remote sensors 14 includes a reference generator 16 that provides a signal that varies as a function of temperature of the IC substrate at each of the respective locations where the remote sensors are located. For example, the reference generator can include an integrated diode that provides a voltage that has a linear functional relationship with respect to temperature. The signals provided by the reference generator 16 thus can correspond to a voltage drop across the integrated diode, thereby providing an analog indication of temperature at each of the respective sensor locations.

An aggregator 18 samples or aggregates the temperature signals from the respective reference generators 16. The aggregator 18 provides an output signal to an analog-to-digital converter (ADC) 20. For example, the aggregator 18 can sample each of the signals from the reference generators 16 sequentially over a predetermined time period. The sampled reference signal (indicative of temperature at the sensor location) can be provided to the ADC 20. The ADC 20 converts the analog signal sampled by the aggregator into a corresponding digital value (e.g., any number of bits), which is provided to a control system 22.

The control system 22 can be operative to determine relative temperature based on the signals provided by the reference generators 16. The control system 22 can be hardware, such as a microcontroller, processor, or state machine configured to operate as described herein. For instance, the control system 22 determines relative temperature at each of the respective remote sensor locations based on the digital values provided by the ADC 20. The control system 22 can employ memory (e.g., registers or programmable read only memory or random access memory) to store the digital values to facilitate the determination. The control system 22 also is operative to control circuitry (depicted as OUT) 24 according to the relative temperatures determined at the respective sensor locations. The control system 22 can independently control the circuitry 24, such as by activating the circuitry at a selected one of the respective remote sensor locations. The activation of the circuitry 24 provides a corresponding signal to an output 26. The output 26 can be utilized by, for example, an off-chip sensor or other circuitry external to the IC 12 that can perform predetermined functions based on the signal provided at the output 26.

As an example, an off-chip sensor can employ the signal provided at the output 26 to determine an indication of temperature for the remote sensor location at which the circuitry 24 has been activated (e.g., corresponding to a “hot spot”). In response to the indication of temperature determined for the respective location, appropriate action may be taken, such as including controlling a cooling device (e.g., a fan). Other appropriate action can also be taken to reduce the temperature at the respective hot spot location as deemed appropriate based on the indication of temperature provided at the output 26. The control system 22 can also provide an indication of temperature, indicated at 28, based upon the digital temperature values for each respective location for the remote sensors. The digital indication of temperature 28 can be employed by other circuitry in the IC 12 to perform power management or take other action as may be appropriate. The digital indication of temperature 28 can be a temperature value or a digital value representing the analog signal generated by one or more of the reference generators 16.

The aggregator 18, the ADC 20 and control system 22 can be co-located on the IC 12. Stated differently, the aggregator 18, the ADC 20 and control system 22 define a central system that samples and performs functions, as described herein, based on the analog signals routed from the reference generators 16 of the remote sensors 14. Since the remote sensors 14 feed their respective signals to central system, the amount of circuitry required to implement each remote sensor can be reduced relative many existing thermal sensing topologies. For sake of efficiency, the ADC 20 can form part of the central system, although separate remote ADCs could be implemented for each remote sensor 14. Additionally to thermal sensing system 10 affords the ability to ascertain a more precise indication of temperature for each sensor location. For example, the control system 22 can determine a temperature value (e.g., by use of an associated look-up table) for each based on the digital information provided by the ADC 20.

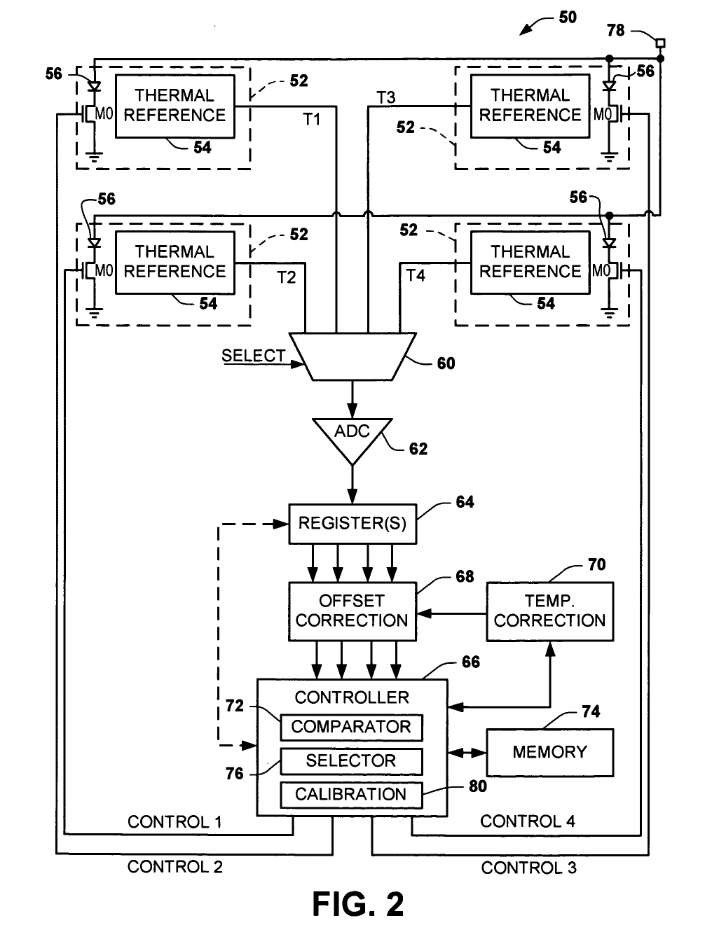

FIG. 2 depicts an example of another thermal sensing system 50. The thermal sensing system 50 includes a plurality of remote sensors 52 distributed across an IC substrate or die. Each of the sensor systems 52 can be strategically located across the IC die, such as at potential hot spots. The potential hot spots can be determined based on expected power consumption for a particular region of the IC. While four remote sensor systems 52 are depicted in FIG. 2, it is to be understood and appreciated that the number of sensors can vary according to design requirements.

Each remote sensor 52 includes a thermal reference 54 and associated circuitry. The thermal references provide respective analog signals T1, T2. T3 and T4, each having a level that varies as a function of temperature of a respective region of the IC die where each respective remote sensor is located. For example, the signals T1, T2. T3 and T4 can correspond to voltage signals based on which a corresponding temperature can be determined.

The associated circuitry for each remote sensor 52 can include a diode 56 connected in series with a switch device, such as an N-channel metal oxide semiconductor field effect transistor (NMOSFET), indicated at M0. The diode 56 can have similar temperature characteristics to the thermal reference 54. As a result, when a respective device M0 is activated to a conductive state, the voltage drop across the diode 56 will vary as a function of temperature in a manner that is substantially proportional to the signal generated by the associated thermal reference 54.

A multiplexer 60 samples the temperature signals T1, T2. T3 and T4 received from each of the thermal references 54. Each thermal reference 54 can feed the multiplexer via wire or other connections in the IC. The multiplexer 60 is controlled by a SELECT signal to provide an output signal to an analog digital converter 62 corresponding to the sampled signal. For example, the SELECT signal can operate the multiplexer 60 to switch in each of the input reference signals in a sequence defined by the SELECT signal. For example, the SELECT signal can control the multiplexer 60 to route the signal from each thermal reference 54 over a time period, which may be fixed or variable.

An analog-to-digital converter 62 in turn converts the analog signal from each thermal reference 54 to a corresponding digital value. The ADC 62 inputs each corresponding digital value to one or more registers 64. For example, the digital value can be implemented as any number of bits (e.g., an eight bit value) sufficient to encode the raw temperature information at a desired accuracy. The digital for each thermal reference 54 can be written to corresponding address locations (or to separate registers) of the register 64. The address location can be set based on the SELECT signal. The temperature value stored in the register for each thermal reference 54 can be an instantaneous value based on the sample provided during a given sample time period. Alternatively, a controller 66 may determine a time-averaged value over a plurality of samples, which value can be stored in the register 64. The controller 66, for example, may be implemented as a microcontroller, processor or state machine configured to implement the functionality described herein. The controller 66 can determine a temperature at each remote sensor location based on the digital temperature values stored in the register 64 signals. For instance, the controller 66 determines the temperature of the die at each sensor location based on the digital values stored in the register 64.

Due to process variations and other factors, each thermal reference 54 may provide the thermal reference signal with a substantially fixed offset (e.g., corresponding to parasitic resistance). The amount of offset associated with the thermal reference 54 can be measured during a testing phase and compensated. For example, in FIG. 2 the thermal sensing system 50 includes an offset correction block 68 that can adjust the stored digital value compensate for the measured offset associated with each respective thermal reference 54.

A temperature correction component 70 can be programmed with offset correction information to adjust each thermal reference signal appropriately. The offset correction block 68 employs the correction values to adjust the digital value stored in the registers 64. As an example, the temperature correction component 70 can be implemented as a fuse bank or register that is set during a calibration mode to establish digital correction values to compensate for the offset associated with each thermal reference. The offset may be the same or different at each of the respective thermal references 54 and the temperature correction component 70 can be configured to accommodate such variations.

The system 50 can be implemented with or without temperature compensation. The controller 66 can obtain uncorrected temperature information from the registers 64, such as when the system 50 does not implement offset correction. The raw temperature values could be provided from the registers 64 to the controller directly (indicated by a dashed line) or propagate through the intervening offset correction circuitry 68 (if implemented).

The controller 66 is also operative to control the transistors M0 according to the relative temperature at the respective sensor locations. The controller 66 activates one of the transistor devices at the selected one of the respective sensor locations to a conductive state according to the relative temperature at the sensor location. The controller 66 includes a comparator 72 that compares the offset corrected temperatures based on the digital values stored in the register 64 for each of the sensing systems 52. The compare block 72 can perform a binary comparison between the offset. Corrected digital values to determine which sensor location has the greatest temperature. For example, the comparator 72 can be configured to identify a lowest digital value, corresponding to the analog signal from the thermal references 54. The lowest digital value defines which location on the die is at a maximum temperature relative to the other sensor locations. Various schemes and circuitry can be employed to determine which remote sensor location has the greatest temperature.

Memory 74 also can be associated with the controller 66. The memory 74, for example, can be programmed to include a look up table that can be employed to convert the stored offset corrected digital value to a corresponding temperature value (e.g., in ° C. or ° F.). For example, the memory 74 can be a read only memory (ROM), programmable ROM (PROM) or the like. The corresponding temperature value can be provided to the register 64 or to another register (not shown) for use by other components in the integrated circuit implementing the sensing system 50. As an alternative, the controller 66 can be programmed to compute a temperature value based on the corrected digital values of temperature stored in the register 64.

The controller 66 also includes a selector 76 that is operative to control the transistor devices M0 based on the comparison performed by the comparator 72. The selector 76, for example, can include driver circuitry coupled to drive a selected one of the transistors M0 to a conductive state according to which sensor location has determined to have the greatest temperature. The anode of each diode 56 is connected to a corresponding output terminal or pin 78 that can be utilized to feed an indication of temperature for the determined hot region to an off chip sensor or other circuitry. In the example of FIG. 2, each of the anodes are electrically coupled to the output 78 corresponding to a hard-wired OR logic function. Thus, when a given one of the transistor devices M0 is activated to its conductive state by the selector 76, electrical current flows through the corresponding diode 56 to electrical ground, thereby enabling external circuitry connected at the output 78 to operate responsive to the temperature in the determined hottest region (e.g., hot spot) of the IC die.

The controller 66 can also implement calibration via a calibration block 80. The calibration block 80 can be implemented (e.g., as circuitry) to configure the temperature correction component 70. The temperature correction component 70 may be implemented on the IC or off chip, depending on design requirements. As an example, the calibration block 80 can cause a substantial uniform temperature to be provided across the IC such that each of the thermal references 54, being similarly configured, should provide the thermal reference signal at the same analog level. Differences between the thermal references signal (either relative to each other or a known reference) as detected and stored in the register 64 correspond to an amount of offset associated with each of the thermal references 54. The calibration block 80 can in turn program the temperature correction component 70 to implement offset correction during the calibration phase so that uniform temperature sensing is achieved.

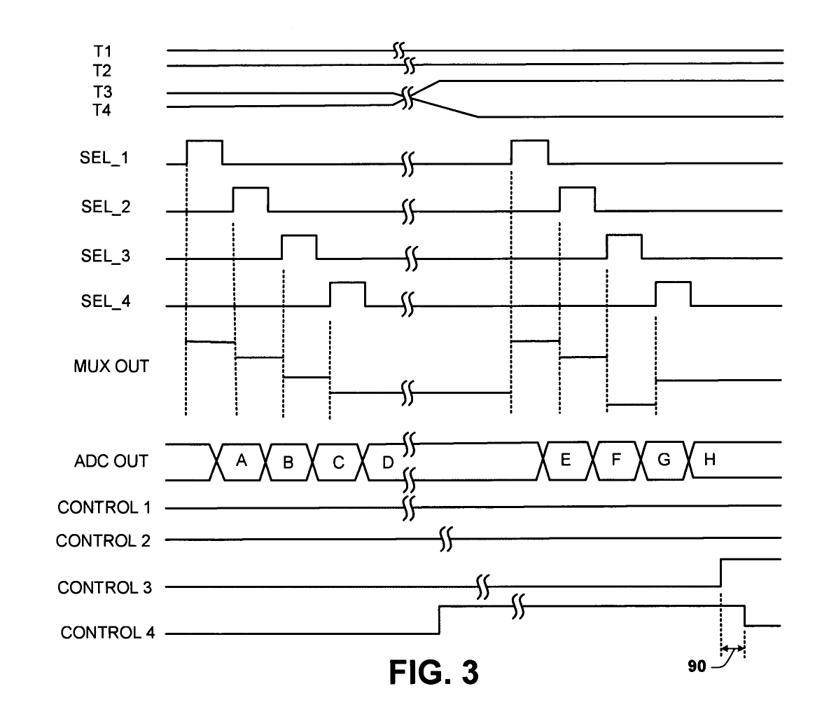

Operation of the thermal sensing system 50 of FIG. 2 will be better appreciated with respect to the timing diagram of FIG. 3. The outputs of the respective thermal references 54 are indicated respectively at T1, T2, T3 and T4. The outputs of the thermal references are depicted as analog signal inversely proportioned to temperature. In the example of FIG. 3, T1 and T2 are substantially constant over the time period depicted in FIG. 3. T3 however is constant and then decreases to a substantially fixed level whereas T4 begins constant and then increases to an increased level.

The SELECT signal provided to the multiplexer 60 is represented as a combination of signals indicated at SEL_1, SEL_2, SEL_3 and SEL_4. Each of these signals is utilized as an input to sample one of the given thermal reference signals T1, T2, T3 and T4. As a result, the output of the multiplexer, indicated MUX OUT corresponds to a sample of each of the respective thermal reference signals T1, T2, T3 and T4 over a sample time period. The ADC converts the analog signal levels associated with the MUX OUT signal to corresponding digital values according to the analog levels at their respective sample time periods. The digital values for a first sample time period are represented as A, B, C, and D. Based on reference signals T1, T2, T3 and T4 for the first illustrated sample time period, A>B>C>D. For the example where the thermal reference signals T1, T2, T3 and T4 correspond to analog voltage drop across respective diodes, the lowest digital value D thus corresponds to a highest relative temperature region for the IC die.

In response to the digital values A, B, C, and D of the associated temperature signals for a first sample time period depicted in FIG. 3, the controller 66 provides control signal CONTROL 4 in response to the digital value D (corresponding to analog level at T4) indicating a highest relative temperature. As a result, the output signal provided at 78 is provided by the region having the highest relative temperature (e.g., a “hot spot”). After a subsequent sample time period, the controller 66 selectively activates the transistor device M0 by providing CONTROL 3 at a high level based on the relative digital values E, F, G, and H provided by the ADC, where E>F>H>G. This situation corresponds to the analog signal T3 decreasing to a lowest relative level, corresponding to a highest temperature in a subsequent sample time period. Accordingly, the output signal provided at 78 for this sample period corresponds to the region that generated reference signal T3.

An overlap, indicated at 90, between control signals CONTROL 4 and CONTROL 3 can be provided to mitigate the occurrence of an open condition being detected by external circuitry. During an open condition, for example, no current conducts at the output 78 due to absence of a control signal to cause current to conduct through any of the associated diodes 56. Thus, an open condition might erroneously indicate the absence of a “hot spot” on the IC to the external circuitry.

FIG. 4 depicts one example of a reference generator circuit. FIG. 4 depicts an example of a reference generator circuit 100. The reference generator circuit 100 includes a current source 102 that supplies a substantially fixed temperature independent current to an associated diode 104. The current source 102 can be implemented as a constant temperature compensated current source that includes an arrangement of transistors. In the example of FIG. 4, the current source 102 includes a PMOSFET device M1 connected in series with an NMOSFET device M2 between a power supply and electrical ground. The current is established through a corresponding resistor R1 that is connected in series with NMOSFET M3 and PMOSFET M4. The current from the current source 102 is mirrored to the diode 104 through a connection of an output PMOSFET device M5 having a gate connected to the drain of M4. Thus, the temperature compensated current through the resistor R1 is mirrored through PMOSFET M5 and through the diode 104.

The voltage across the diode 104 varies as a function of temperature when it is forward biased by the substantially constant current flowing through the diode. Because the current through the diode 104 is constant, changes in the voltage across the diode 104 can be utilized to provide an indication of the temperature in the region of the IC die in which the diode 104 is implemented.

As described herein, the diode 104 may have a finite amount of parasitic resistance that is essentially nulled by feeding a constant current through the diode 104. Accordingly, offset associated with the diode 104 appears as a fixed offset during operation. The fixed offset through the diode 104 can be measured and compensated as described herein.

It is to be understood and appreciated that the thermal reference circuit 100 depicted in FIG. 4 (e.g., an emitter-follower configuration) is but one example of thermal reference that can be utilized as remote sensor. Various other types of configurations and topologies of reference circuits can be utilized for generating a reference that varies as a function of temperature. For example, there exists numerous band gap current source circuits and other implementations, such as utilizing CMOS or BICMOS technologies.

In view of the foregoing structural and functional features described above, certain methods will be better appreciated with reference to FIGS. 6 and 7. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., an integrated circuit, a computer system), software (e.g., as executable instructions running on one or more microcontrollers or processors), or any combination of hardware and software.

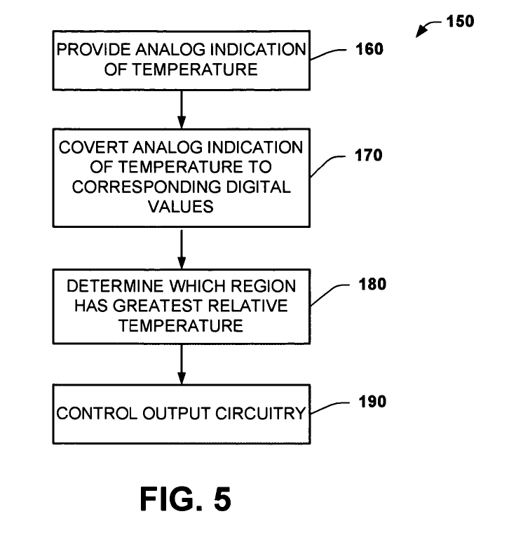

FIG. 5 depicts an example of a method 150 that can be performed by an IC. The method 150 includes providing an analog indication of temperature a plurality of predetermined regions across the IC, as shown at 160. At 170, the analog indication of temperature for the plurality of predetermined regions are converted to corresponding digital values. At 180, the method includes determining which of the plurality of predetermined regions has a greatest relative temperature based on the corresponding digital values. At 190, output circuitry located at the predetermined regions across the IC is controlled according to which of the plurality of predetermined regions is determined as having the greatest relative temperature.

What have been described above are examples of the present invention. It is, of course, not possible to describe every conceivable combination of components or methodologies for purposes of describing the present invention, but one of ordinary skill in the art will recognize that many further combinations and permutations of the present invention are possible. For example, while certain embodiments of the thermal sensing system have been described with respect to MOSFET transistors, the thermal sensing system is not limited to any type of transistor topology. Accordingly, the present invention is intended to embrace all such alterations, modifications, and variations that fall within the spirit and scope of the appended claims.

What is claimed is:

1. A thermal sensing system, comprising:
a plurality of remote sensors distributed across an integrated circuit (IC), each of the plurality of remote sensors providing an analog signal that varies as a function of temperature of a respective region of the IC where each respective remote sensor is located; and
a central system, forming part of the IC, that samples the analog signals from the plurality of remote sensors and converts the sampled analog signals to corresponding digital values.

2. The system of claim 1, wherein each of the plurality of remote sensors comprises:
a first circuit that provides the analog signal; and
a second circuit that provides an output signal, the central system independently controlling the second circuits based on relative temperature of the respective regions of the IC determined the corresponding digital values.

3. The system of claim 2, wherein the first circuit of a given one of the plurality of remote sensors further comprises a diode through which a substantially fixed current is sourced, the second circuit of the given one of the plurality of remote sensors further comprising a diode that is activated to conduct current through the diode in response to a control signal from the central system, the control signal activating the diode in the second circuit of the given one of the plurality of remote sensors based on a comparison of the corresponding digital values indicating that the temperature of the IC at the respective region where the given one of the plurality of remote sensors is located exceeds the temperature of the IC where the other of the plurality of remote sensors are located.

4. The system of claim 1, wherein the central system further comprises an aggregator that samples the analog signals from the plurality of remote sensors and provides a sample signal corresponding to the sampled signals over a sample time period.

5. The system of claim 4, wherein the central system further comprises an analog-to-digital converter that converts the sampled analog signal from the aggregator into the corresponding digital values.

6. The system of claim 1, wherein the central system further comprises:
a comparator that compares the corresponding digital values for the respective regions of the IC to identify which of the respective regions has a greatest relative temperature; and
a selector that activates output circuitry of the IC that is associated with a selected one of the plurality of remote sensors according to which of the respective regions is identified as having the greatest temperature.

7. The system of claim 1, further comprising offset correction that is applied to the digital values to compensate for offset in the analog signals to provide an offset corrected corresponding digital value that is functionally related to temperature for the respective regions of the IC.

8. The system of claim 7, wherein the central system further comprises a calibration component that is operative to determine the offset correction that is applied to the corresponding digital values for each of the respective regions of the IC.

9. The system of claim 1, wherein the central system further comprises:
memory that stores the corresponding digital values; and
a control system operative to determine a corresponding temperature value for at least a portion of the respective regions of the IC based on the digital values stored in the memory.

10. The system of claim 1, wherein the central system is operative to determine respective temperature values based on the corresponding digital values.

11. A thermal sensing system comprising:
a plurality of thermal references disposed at predetermined locations across an integrated circuit (IC) die, each of the plurality of thermal references providing a signal that varies as a function of temperature of the IC die at each of the predetermined locations;
an output circuit associated with and located proximal to each of the plurality of thermal references at each of the predetermined locations; and
a control system on the IC die that is coupled with each of the output circuits, the control system providing a control signal to activate the output circuit at one of the predetermined locations according to a relative temperature at the predetermined locations, the relative temperature being determined based on the signals provided by the plurality of thermal references.

12. The system of claim 11, wherein the signals from the plurality of thermal references are analog signals, the system further comprising:
an aggregator that samples the analog signals provided from the plurality of thermal references during a sample time period; and
an analog-to-digital converter that converts the sampled analog signals to corresponding digital values.

13. The system of claim 12, wherein the control system further comprises:
a comparator that compares the corresponding digital values for the predetermined locations of the IC die to identify which of the predetermined locations has a greatest relative temperature; and
a selector that provides the control signal to the output circuit at a selected one of the predetermined locations according to which of the predetermined location is identified as having the greatest relative temperature.

14. The system of claim 12, further comprising integrated memory that stores the corresponding digital values, the control system being operative to determine respective temperature values based on the corresponding digital values.

15. The system of claim 11, further comprising:
offset correction that is applied to the digital values to compensate for offset in the analog signals to provide an offset corrected indication of temperature for the predetermined locations of the IC die; and
a calibration component that is operative to determine the offset correction that is applied to the digital values for each of the predetermined locations of the IC die.

16. The system of claim 11, wherein the control system is operative to determine a corresponding temperature value for at least a portion of the predetermined locations of the IC die based on the corresponding digital values, the control system providing an output signal to identify the corresponding temperature value for the at least a portion of the predetermined locations of the IC die.

17. The system of claim 11, wherein each of the thermal references comprises a diode through which a substantially fixed current is sourced, each of the output circuits further comprise a diode through which current is sourced in response to the control signal provided by the control system, the output circuits being connected to a common output such that the signal a the common output provides an indication of temperature for the predetermined location having a greatest relative temperature.

18. An integrated thermal sensing system comprising:
means for providing an analog indication of temperature for a plurality of predetermined regions across an integrated circuit (IC) die;
means for sampling the analog indication of temperature for the plurality of predetermined regions;
means for converting the analog indication of temperature for the plurality of predetermined regions to corresponding digital values;
means for identifying which of the plurality of predetermined regions has a greatest relative temperature based on the corresponding digital values; and
means for providing a control signal based on which of the plurality of predetermined regions is identified as having the greatest relative temperature.

19. The system of claim 18, further comprising means, located at each of the plurality of predetermined locations, for providing an output signal to an output that is accessible by circuitry external to the IC die based on the control signal.

20. The system of claim 19, wherein each of the means for providing an analog indication of temperature and each of the means for providing an output signal further comprises a diode that, when biased to conduct current, has an analog voltage drop across the respective diode that varies substantially linearly as a function of the temperature at the predetermined region of the IC die where the respective diode is located.

21. The system of claim 18, further comprising:
means for storing the corresponding digital values; and
means for determining a corresponding temperature value for each of the predetermined regions of the IC die based on the stored corresponding digital values.

22. The system of claim 18, further comprising:
means for compensating for an offset in at least a portion of the analog signals by adjusting the corresponding digital values to provide an offset corrected digital indication of temperature for the predetermined regions of the IC die; and
means for calibrating the means for compensating.

23. The system of claim 18, wherein the means for identifying further comprises a comparator that compares the corresponding digital values for the respective regions of the IC die to identify which of the respective regions has a greatest relative temperature.

24. An integrated circuit (IC) configured to perform a method, the method comprising:
providing an analog indication of temperature a plurality of predetermined regions across the IC;
converting the analog indication of temperature for the plurality of predetermined regions to corresponding digital values;
determining which of the plurality of predetermined regions has a greatest relative temperature based on the corresponding digital values; and
controlling output circuitry located at the predetermined regions across the IC according to which of the plurality of predetermined regions is determined as having the greatest relative temperature.

25. The method of claim 24, further comprising providing an output signal from the output circuitry to an output that is accessible by other circuitry that is external to the IC.

26. The method of claim 24, further comprising:
storing the corresponding digital values on the IC; and
determining a corresponding temperature value for each of the predetermined regions of the IC based on the stored corresponding digital values.

27. The method of claim 24, further comprising:
compensating for offset in the analog signals by adjusting the corresponding digital values; and
calibrating the amount of compensation that is applied to adjust the digital values.
